(19) United States
(12) Patent Application Publication
(10) Pub. No.: US 2013/0291827 A1
(43) Pub. Date: Nov. 7, 2013

(54) INTERNAL COMBUSTION CYCLONE ENGINE

(71) Applicant: Byung Hahn HAH, Houston, TX (US)

(72) Inventor: Byung Hahn HAH, Houston, TX (US)

(21) Appl. No.: 13/461,971

(22) Filed: May 2, 2012

(51) Int. Cl. F02F 3/26

(52) U.S. Cl. 123/279

(57) ABSTRACT

An internal combustion cyclone engine includes a gas hole, a gas hole plugging protrusion, and oblique holes. The gas hole is provided in the piston, and connects the explosion chamber with the combustion chamber. The gas hole plugging protrusion is provided in the cylinder and configured to be inserted into and seal the gas hole while the piston is pushed up. Oblique holes are provided around the gas hole through the top plate portion of the piston, and each of the oblique holes connects the explosion chamber with the combustion chamber concentrically and obliquely. At the top dead center the top plate portion of the piston almost touches the top wall portion of the cylinder. At the start of the expansion phase before ignition substantially all of the compressed gas is in the explosion chamber and whirls around inside the explosion chamber during the compression phase.

### BACKGROUND OF THE INVENTION

The invention relates to an internal combustion engine, in which the combustion efficiency of fuel through the engine cycles including compression phase, explosion, and expansion phase is increased so as to increase the engine output and stability.

More specifically, the invention relates to a structure of a cylinder head and a piston in an internal combustion engine.

Prior arts suggested many ways to increase the combustion efficiency of fuel and the output power of the engine. Some methods tried to adjust a combustion environment of fuel inside the engine during an expansion phase in order to convert the combustion energy to power efficiently. Still another methods tried to facilitate an efficient conversion when the power of the combustion energy to a moment of crankshaft.

In still other prior arts, a crank piston structure adjusts travel distances in some phases of the engine compared with them in other phases. A travel distance of the piston during the expansion phase or the exhaust phase can be longer than a travel distance of the piston during the intake phase or the compression phase.

Since the internal combustion engine includes a plurality of parts, there should be some parts, which the efficiency of the engine can be improved a lot by improving of. Always there should be some issues which can be improved.

The invention has been needed for solving the above problems in the prior arts, and provides solutions for increasing efficiency of internal combustion engines using gasoline, hydrogen, and diesel as fuel.

### SUMMARY OF INVENTION

An objective of the invention is to provide an internal combustion cyclone engine, which can increase the efficiency of internal combustion engine.

An internal combustion cyclone engine includes a cylinder, piston, an explosion chamber, a gas hole, a gas hole plugging protrusion, and a plurality of oblique holes.

The cylinder has a top wall portion, a side round wall portion, and a bottom opening.

The piston is configured to travel through the cylinder, and the piston has a top plate portion, a bottom plate portion,and a side round plate portion connecting the top plate portion and the bottom plate portion, wherein the top plate portion of the piston defines a combustion chamber with the top wall portion and the side round wall portion of the cylinder.

The explosion chamber is provided in the piston.

The gas hole is provided through a central potion of the top plate portion of the piston, and the gas hole connects the explosion chamber with the combustion chamber.

The gas hole plugging protrusion is provided on the top wall portion of the cylinder and configured to be inserted into the gas hole and seal the gas hole while the top plate portion of the piston is pushed up from a predetermined vertical location to the top wall portion.

The plurality of oblique holes are provided around the gas hole through the top plate portion of the piston, and each of the plurality of oblique holes connects the explosion chamber with the combustion chamber concentrically and obliquely from a top opening to a bottom opening.

The internal combustion cyclone engine goes through an engine cycle comprising an intake phase, a compression phase, a expansion phase, and a exhaust phase.

During the intake phase the piston travels from a top dead center of the cylinder to a bottom dead center of the cylinder.

During the compression phase the piston travels from the bottom dead center of the cylinder to the top dead center of the cylinder.

During the expansion phase the piston travels from the top dead center of the cylinder to the bottom dead center.

During the exhaust phase the piston travels from the bottom dead center of the cylinder to the top dead center.

At the top dead center the top plate portion of the piston touches the top wall portion of the cylinder barely reducing volume of the combustion chamber to substantially zero.

At the start of the expansion phase before ignition substantially all of the compressed gas is in the explosion chamber and whirls around inside the explosion chamber with a torque imparted by the plurality of oblique holes during the compression phase.

Combustion efficiency and explosion strength can be determined by shape, width, and depth of the explosion chamber.

The gas hole plugging protrusion can have a cross-sectional shape fitted to the gas hole.

The predetermined vertical location can be adjusted by a height of the gas hole plugging protrusion.

Each of the gas hole and the gas hole plugging protrusion can extend vertically.

Each of the plurality of oblique holes can be slanted so as to impart a maximum torque to the compressed gas in the explosion chamber during the compression phase.

The plurality of oblique holes can be disposed evenly around the gas hole.

The explosion of the compressed gas can be confined substantially in the explosion chamber while the gas hole plugging protrusion seals the gas hole.

The internal combustion cyclone engine can further include a spark plug provided at a lower end of the gas hole plugging protrusion so that the spark plug is in the explosion chamber at the end of the compression phase.

The piston can be configured to absorb substantially all shock and noise of the explosion in the explosion chamber so as to reduce the shock and noise transmitted to rest of the body of the internal combustion cyclone engine.

The time for the explosion to be delivered from the explosion chamber to the combustion chamber can be determined by diameter and length of the gas hole plugging protrusion.

The internal combustion cyclone engine can further include a plurality of oblique-hole stoppers disposed on the top wall portion of the cylinder for blocking the corresponding oblique holes so as to seal the explosion chamber during the explosion of the compressed gas.

The internal combustion cyclone engine can further include a crankshaft disposed below the cylinder, a connecting rod comprising a upper end and a lower end, wherein the upper end is rotatably connected to the bottom plate portion of the piston and the lower end is rotatably connected to the crankshaft, an intake valve, and an exhaust valve.

A fuel for the internal combustion engine can include gasoline, hydrogen, and diesel.

Therefore, according to the invention, it is possible to change one of the travel distance of the piston during one or two phases of the engine. The increased travel distance of the piston means that the size of the space in the cylinder may be increased such that the conversion from a fuel to power gets more efficient. The increased travel distance of the piston may be given by the diameter of rotation of a rotating connector.

### BRIEF DESCRIPTION OF DRAWINGS

FIG. 1 is a simplified cross-sectional view showing an internal combustion cyclone engine according to an embodiment of the invention;

FIG. 2 is a front view showing a piston according to an embodiment of the invention;

FIG. 3 is a cross-sectional view showing the piston of FIG. 2;

FIG. 4 is a cross-sectional view showing an oblique hole along a line perpendicular to that of FIG. 3;

FIG. 5 is a top view showing the oblique holes in FIG. 3;

FIG. 6 is a simplified cross-sectional view showing a piston with a closed explosion chamber at the top dead center according to an embodiment of the invention;

FIG. 7 is a simplified cross-sectional view showing a piston at the bottom dead center according to an embodiment of the invention; and

FIG. 8 is a simplified cross-sectional view showing a piston closing the gas hole according to an embodiment of the invention.

### DETAILED DESCRIPTION OF EMBODIMENTS OF THE INVENTION

In a regular internal combustion engine, the fuel is introduced into the combustion chamber with air through the intake phase, and when the compression phase is finished, that is, when the piston reaches the highest point of the cylinder, the fuel is highly compressed and located in an upper space of the combustion chamber as a stationary mixed gas with air.

And then the fuel is ignited by the spark plug and combusts, the compressed gas explodes, and the explosion energy have the combusted gas expanded during the expansion phase, generating engine output.

However, in such a conventional internal combustion engine, when the compression phase is over, the engine fuel mixed with air exists in the upper space of the combustion chamber as a highly compressed and stationary gas. Then the spark plug ignites the compressed and stationary gas, generating power.

In order to improve the above internal combustion engine, the present invention provides and explosion chamber in the piston and a gas hole plugging protrusion in the cylinder head. Due to this structural feature, the compressed mixed gas whirls around in the explosion chamber when the compression phase is over. Then, as the compressed mixed fuel gas was whirling around when ignited to combust by the spark plug, the combustion efficiency is increased, and therefore the explosion energy from the explosion is improved.

Also, since the combusted gas moves upward from the lower portion of the combustion chamber even during the expansion phase in which the piston moves downward, the expansion of the combusted gas is increased due to the facilitated flow of energy and the engine output is increased.

Additionally, since the compressed mixed gas explodes in the explosion chamber in an upper portion of the piston, the shock and noise from the explosion is reduced to be transferred to the engine body, increasing the stability of the engine.

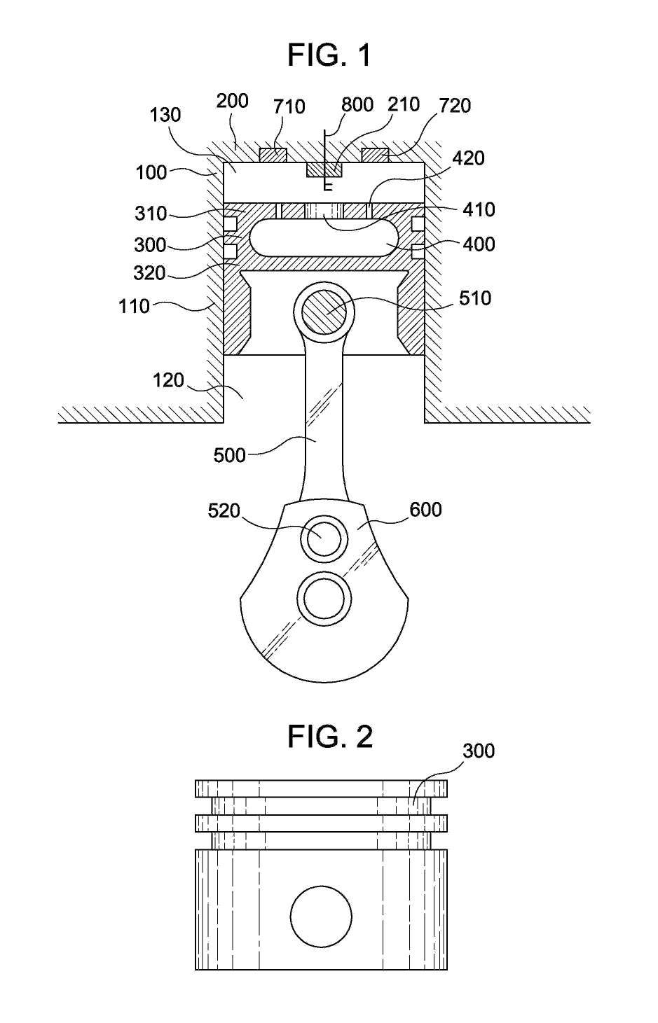

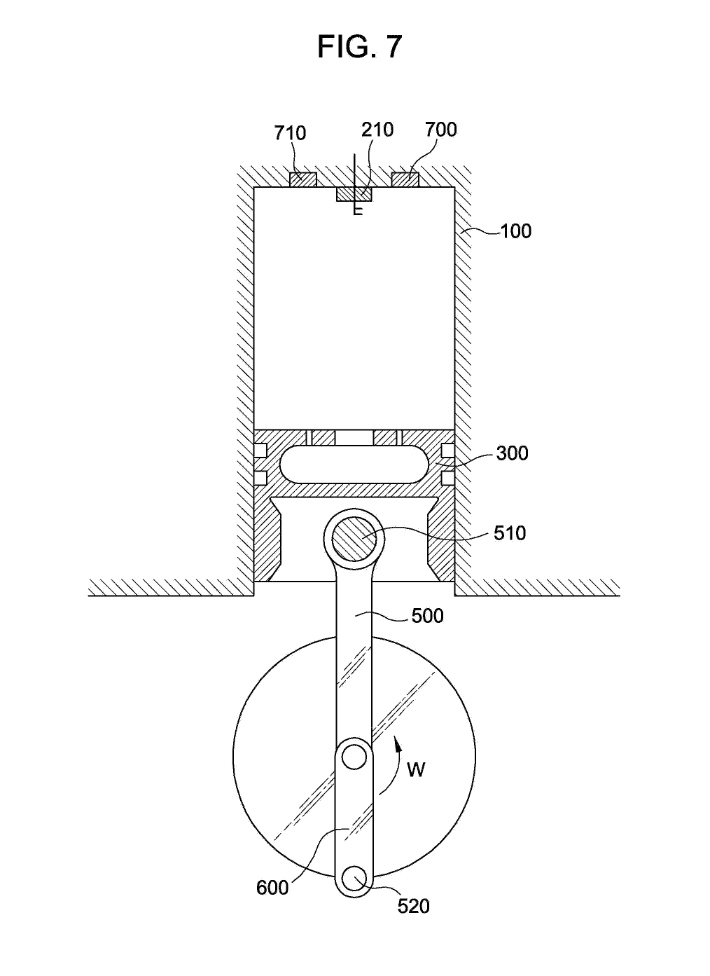

FIGS. 1 and 6-8 show an internal combustion cyclone engine according to embodiments of the invention, and FIGS. 2-5 show the structures of a piston of the internal combustion cyclone engine.

An internal combustion cyclone engine includes a cylinder 100, a piston 300, an explosion chamber 400, a gas hole 410, a gas hole plugging protrusion 210, and a plurality of oblique holes 420.

The cylinder 100 has a top wall portion or cylinder head 200, a side round wall portion 110, and a bottom opening 120.

The piston 300 is configured to travel through the cylinder 100, and the piston 300 has a top plate portion 310, a bottom plate portion 320, and a side round plate portion connecting the top plate portion 310 and the bottom plate portion 320, wherein the top plate portion 310 of the piston 300 defines a combustion chamber 130 with the top wall portion 200 and the side round wall portion 110 of the cylinder 100 as shown in FIG. 1.

The explosion chamber 400 is provided in the piston 300. The explosion chamber 400 is enclosed by the top plate portion 310, the bottom plate portion 320, and the side round plate portion.

The gas hole 410 is provided through a central potion of the top plate portion 310 of the piston 300, and the gas hole 410 connects the explosion chamber 400 with the combustion chamber 130. In certain embodiments, the gas hole 410 is circular in cross-section and provided at the center of the circular top plate portion 310. Of course, the cross-sectional shape of the gas hole 410 can be of any shape, which corresponds to the shape of the gas hole plugging protrusion 210.

The gas hole plugging protrusion 210 is provided on the top wall portion 200 of the cylinder 100 and configured to be inserted into the gas hole 410 and seal the gas hole 410 while the top plate portion 310 of the piston 300 is pushed up from a predetermined vertical location to the top wall portion 200.

The plurality of oblique holes 420 are provided around the gas hole 410 through the top plate portion 310 of the piston 300, and each of the plurality of oblique holes connects the explosion chamber 400 with the combustion chamber 130 concentrically and obliquely from a top opening to a bottom opening.

The internal combustion cyclone engine goes through an engine cycle comprising an intake phase, a compression phase, a expansion phase, and a exhaust phase.

During the intake phase the piston 300 travels from a top dead center of the cylinder to a bottom dead center of the cylinder.

During the compression phase the piston 300 travels from the bottom dead center of the cylinder to the top dead center of the cylinder.

During the expansion phase the piston 300 travels from the top dead center of the cylinder to the bottom dead center.

During the exhaust phase the piston 300 travels from the bottom dead center of the cylinder to the top dead center.

At the top dead center the top plate portion 310 of the piston 300 touches the top wall portion 200 of the cylinder barely reducing volume of the combustion chamber 130 to substantially zero.

At the start of the expansion phase before ignition substantially all of the compressed gas is in the explosion chamber 400 and whirls around inside the explosion chamber 400 with a torque imparted by the plurality of oblique holes 420 during the compression phase.

Combustion efficiency and explosion strength can be determined by shape, width, and depth of the explosion chamber 400.

The gas hole plugging protrusion 210 can have a cross-sectional shape fitted to the gas hole 410.

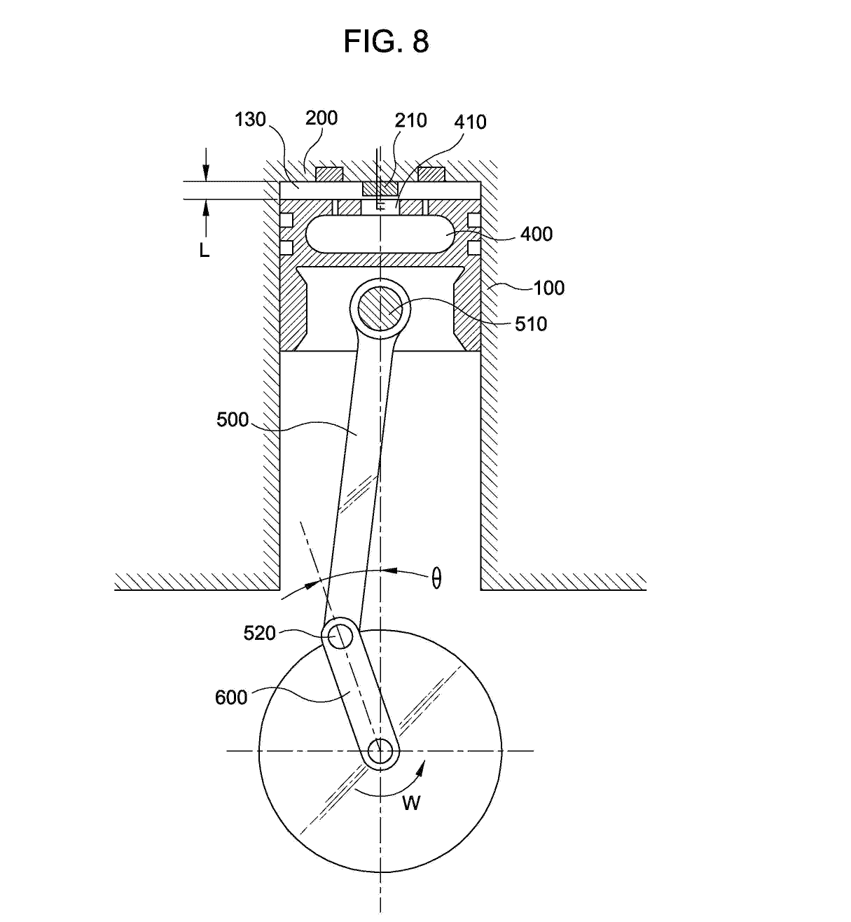

The predetermined vertical location can be adjusted by a height of the gas hole plugging protrusion 210. The predetermined vertical location is a location of the cylinder 100 where the gas hole plugging protrusion 210 starts to plug the gas hole 410. FIG. 8 is at the right moment of this situation except for that the piston 300 is coming down.

Each of the gas hole 410 and the gas hole plugging protrusion 210 can extend vertically.

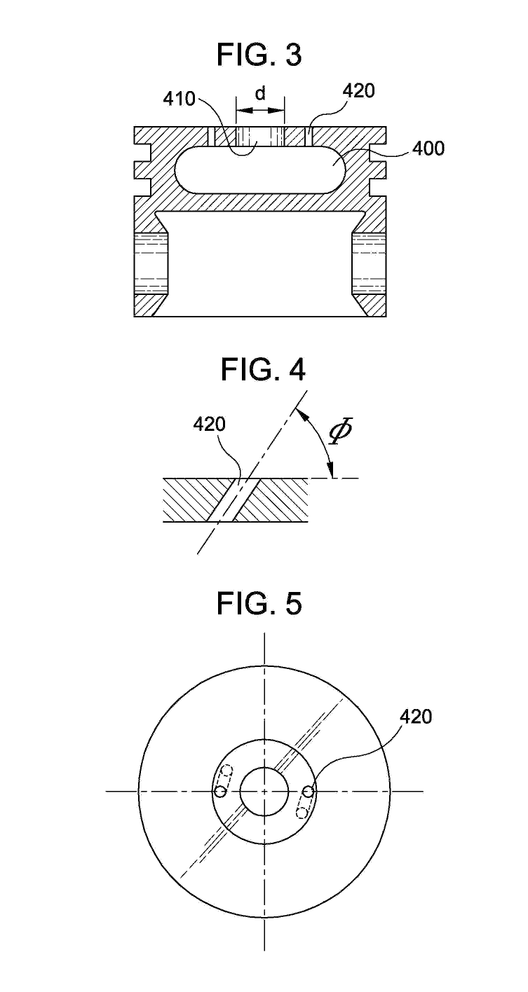

Each of the plurality of oblique holes 420 can be slanted so as to impart a maximum torque to the compressed gas in the explosion chamber 400 during the compression phase. In an embodiment illustrated in FIGS. 3-5, the internal combustion cyclone engine includes only two oblique holes 420 that are disposed at opposite positions with respect to the gas hole 410. The direction of tilting of the two oblique holes 420 can be seen clearly there.

The plurality of oblique holes 420 can be disposed evenly around the gas hole 410.

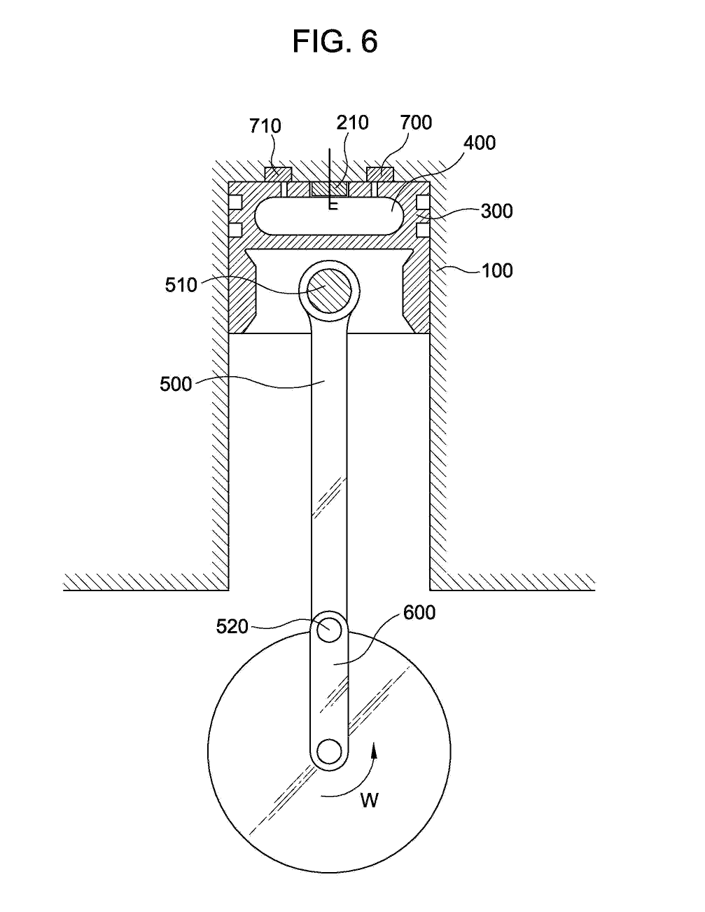

The explosion of the compressed gas can be confined substantially in the explosion chamber 400 while the gas hole plugging protrusion 210 seals the gas hole 410 as shown in FIG. 6.

The internal combustion cyclone engine can further include a spark plug 800 provided at a lower end of the gas hole plugging protrusion 210 so that the spark plug is in the explosion chamber 400 at the end of the compression phase and right before ignition.

The piston 300 can be configured to absorb substantially all shock and noise of the explosion in the explosion chamber 400 so as to reduce the shock and noise transmitted to rest of the body of the internal combustion cyclone engine.

The time for the explosion to be delivered from the explosion chamber 400 to the combustion chamber 130 can be determined by diameter (d) and length of the gas hole plugging protrusion 210.

The internal combustion cyclone engine can further include a plurality of oblique-hole stoppers 710, 720 disposed on the top wall portion 200 of the cylinder 100 for blocking the corresponding oblique holes 420 so as to seal the explosion chamber 400 during the explosion of the compressed gas as shown in FIG. 6. Each of the oblique-hole stoppers 710, 720 can protrude a little downward so as to secure the blocking of the corresponding oblique holes 420.

The internal combustion cyclone engine can further include a crankshaft 600 disposed below the cylinder 100, a connecting rod 500 comprising a upper end and a lower end, wherein the upper end is rotatably connected to the bottom plate portion 320 of the piston 300 at 510 and the lower end is rotatably connected to the crankshaft 600 at 520, an intake valve (not shown), and an exhaust valve (not shown).

A fuel for the internal combustion engine can comprise gasoline, hydrogen, and diesel.

In FIG. 3, if the spark plug 800 ignites after the compression phase, then the compressed and whirling engine fuel in the explosion chamber 400 combusts and the compressed gas explodes, starting the expansion phase from the top dead center of the cylinder.

By adjusting the shape, width, and depth of the explosion chamber 400,the combustion efficiency of the engine fuel and the explosion power of the compressed gas can be adjusted.

In the beginning of the expansion phase, until the gas hole 410 of the piston 300 is off with the gas hole plugging protrusion 210 as shown in FIG. 5, the combusted gas in the explosion chamber 400 goes out to the cylinder space or combustion space 130 through the oblique holes 420, and at that moment, the combusted gas obtains torque, and the explosion energy from the combustion chamber 130 generates expansion power and acts on the piston 300.

During the expansion phase, as shown in FIG. 5, in order to obtain a big change in expansion power of the combusted gas in the combustion chamber 130 where the crankshaft 600 is at an angular position of θ, the time for the explosion energy generated in the explosion chamber 400 to go out to the combustion chamber 130 can be adjusted by adjusting the diameter and length of the gas hole plugging protrusion 210 at the cylinder head 200.

During the expansion phase after the crankshaft 600 rotates by a specific angle θ, until the piston 300 reaches the bottom dead center, the combusted gas goes out to the combustion chamber through the oblique holes or jet propulsion generator 420 and the gas hole 410, and the piston moves by the expansion power of the combusted gas in the combustion chamber 130 and the explosion chamber 400.

The exhaust phase is performed, when the expansion phase is over, while the piston 300 moves from the bottom dead center to the top dead center by the rotational force of the crankshaft 600.

In the conventional internal combustion engine, the explosion energy of the engine fuel during the expansion phase generates expansion power to the combusted gas in the combustion chamber 130 and operates the piston. However, in the present invention, since the combusted gas in the explosion chamber and the explosion power move to the combustion chamber, the flow of the combusted gas and the explosion energy is facilitated, and the expansion power of the combusted gas gets much larger.

Also, when the compressed engine fuel combusts and the compressed gas explodes, in the present invention, as shown in FIG. 3, the explosion chamber 400 is formed by the piston 300 and the gas hole plugging protrusion 210 at the cylinder head, the shock of the moment of explosion of the compressed gas is reduced to be transferred to the engine body.

In FIG. 4, the angle φ of the oblique hole 420 can be adjusted to optimize the whirling of the compressed gas in the explosion chamber 400 during the compression phase.

In FIGS. 6 and 8, the crankshaft 600 rotates with an angular velocity ω.

The present invention improves the engine output and stability in an internal combustion engine through increasing the combustion efficiency of engine fuel and controlling the combustion energy.

Although a preferred embodiment of the present invention is disclosed for illustrative purposes, those skilled in the art will appreciate that various modifications, additions and substitutions are possible, without departing from the scope and spirit of the invention as disclosed in the accompanying claims.

What is claimed is:

1. An internal combustion cyclone engine comprising:
a cylinder comprising a top wall portion, a side round wall portion, and a bottom opening;
a piston configured to travel through the cylinder, the piston comprising a top plate portion, a bottom plate portion,and a side round plate portion connecting the top plate portion and the bottom plate portion, wherein the top plate portion of the piston defines a combustion chamber with the top wall portion and the side round wall portion of the cylinder;
an explosion chamber provided in the piston;
a gas hole provided through a central potion of the top plate portion of the piston, the gas hole connecting the explosion chamber with the combustion chamber;
a gas hole plugging protrusion provided on the top wall portion of the cylinder and configured to be inserted into the gas hole and seal the gas hole while the top plate portion of the piston is pushed up from a predetermined vertical location to the top wall portion; and
a plurality of oblique holes provided around the gas hole through the top plate portion of the piston, each of the plurality of oblique holes connecting the explosion chamber with the combustion chamber concentrically and obliquely from a top opening to a bottom opening,
wherein the internal combustion cyclone engine goes through an engine cycle comprising an intake phase, a compression phase, a expansion phase, and a exhaust phase,
wherein during the intake phase the piston travels from a top dead center of the cylinder to a bottom dead center of the cylinder,
wherein during the compression phase the piston travels from the bottom dead center of the cylinder to the top dead center of the cylinder,
wherein during the expansion phase the piston travels from the top dead center of the cylinder to the bottom dead center,
wherein during the exhaust phase the piston travels from the bottom dead center of the cylinder to the top dead center,
wherein at the top dead center the top plate portion of the piston touches the top wall portion of the cylinder barely reducing volume of the combustion chamber to substantially zero,
wherein at the start of the expansion phase before ignition substantially all of the compressed gas is in the explosion chamber and whirls around inside the explosion chamber with a torque imparted by the plurality of oblique holes during the compression phase.

2. The internal combustion cyclone engine of claim 1, wherein combustion efficiency and explosion strength are determined by shape, width, and depth of the explosion chamber.

3. The internal combustion cyclone engine of claim 1, wherein the gas hole plugging protrusion has a cross-sectional shape fitted to the gas hole.

4. The internal combustion cyclone engine of claim 3, wherein the predetermined vertical location is adjusted by a height of the gas hole plugging protrusion.

5. The internal combustion cyclone engine of claim 3, wherein each of the gas hole and the gas hole plugging protrusion extends vertically.

6. The internal combustion cyclone engine of claim 1, wherein each of the plurality of oblique holes is slanted so as to impart a maximum torque to the compressed gas in the explosion chamber during the compression phase.

7. The internal combustion cyclone engine of claim 6, wherein the plurality of oblique holes are disposed evenly around the gas hole.

8. The internal combustion cyclone engine of claim 1, wherein the explosion of the compressed gas is confined substantially in the explosion chamber while the gas hole plugging protrusion seals the gas hole.

9. The internal combustion cyclone engine of claim 8, further comprising a spark plug provided at a lower end of the gas hole plugging protrusion so that the spark plug is in the explosion chamber at the end of the compression phase.

10. The internal combustion cyclone engine of claim 8, wherein the piston is configured to absorb substantially all shock and noise of the explosion in the explosion chamber so as to reduce the shock and noise transmitted to rest of the body of the internal combustion cyclone engine.

11. The internal combustion cyclone engine of claim 1, wherein time for the explosion to be delivered from the explosion chamber to the combustion chamber is determined by diameter and length of the gas hole plugging protrusion.

12. The internal combustion cyclone engine of claim 1, further comprising a plurality of oblique-hole stoppers disposed on the top wall portion of the cylinder for blocking the corresponding oblique holes so as to seal the explosion chamber during the explosion of the compressed gas.

13. The internal combustion cyclone engine of claim 1, further comprising:
a crankshaft disposed below the cylinder;
a connecting rod comprising a upper end and a lower end, wherein the upper end is rotatably connected to the bottom plate portion of the piston and the lower end is rotatably connected to the crankshaft,
an intake valve; and
an exhaust valve.
